(19) United States
(12) Patent Application Publication
(10) Pub. No.: US 2004/0111342 A1
(43) Pub. Date: Jun. 10, 2004

(54) General ledger management system and method

(76) Inventor: Juei-Mei Wang, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/405,879

(22) Filed: Apr. 1, 2003

(30) Foreign Application Priority Data
Dec. 6, 2002 (TW) 91135348

(51) Int. Cl. G06F 17/60

(52) U.S. Cl. 705/35

(57) ABSTRACT

A general ledger management system includes client computers (10), a database (14), and an application server (12). The application server includes a journal ledger management unit (23), a voucher carrying forward unit (24), a posting unit (25), an account balancing unit (26), and a statement generating unit (27). The journal ledger management unit is for setting different types of vouchers, and entering the vouchers to a general ledger. The voucher carrying forward unit is for automatically carrying forward subsidiary ledgers of an external financial system to vouchers of the general ledger. The posting unit is for entering data in vouchers to transaction records of accounting subjects of the general ledger, and calculating gross balances of the accounting subjects. The account balancing unit is for balancing accounts to obtain closing balances. The statement generating unit is for generating various financial statements according to statement generating conditions and templates set by users.

### BACKGROUND OF THE INVENTION

1. Field of the Invention

The present invention relates to a financial data analysis system and method, and particularly to a general ledger management system and method that can automatically integrate information from external financial systems.

2. Background of the Invention

Efficient financial management is vital for companies such as vast multinational manufacturing corporations. General ledger management pertains to financial subsystems of a company, and provides managers at different levels with all kinds of managerial reports that directly relate to decisions of the company. A general ledger management system can integrate with accounts receivable management subsystems, accounts payable management subsystems, note management subsystems and cash management subsystems of corresponding external financial systems. Accordingly, the general ledger management system can calculate financial data such as accounting subjects, management fees and advance charges, and generate consolidated financial statements.

Computer-aided general ledger management systems are disclosed in a number of patents. However, most of these general ledger management systems are not connected to external financial systems. In such cases, when analyzing financial data, a user needs to input accounting subjects of financial subsystems to the general ledger management system one by one. Even for those patents that do disclose a general ledger management system connected to external financial systems, the general ledger management system does not have functions of generating transaction entries and accounting vouchers automatically, and defining fiscal periods and formats to produce individualized managerial reports.

### SUMMARY OF THE INVENTION

Accordingly, a main objective of the present invention is to provide a general ledger management system and method which can automatically integrate with external financial systems and reduce manual inputting of data.

Another objective of the present invention is to provide a general ledger management system and method which can automatically generate transaction entries according to settings of relevant accounting subjects, and generate accounting vouchers for receipt of information from external financial systems.

A further objective of the present invention is to provide a general ledger management system and method, whereby users can define fiscal periods and formats to generate a variety of different financial statements for managerial reports.

To accomplish the above objectives, a general ledger management system in accordance with a preferred embodiment of the present invention comprises a plurality of client computers, a database server, and an application server. Each client computer provides a user interface for inputting and displaying financial data. The database server comprises a database for storing information such as opening balances and closing balances of accounting subjects. The application server comprises: an authorization control unit for defining and controlling operational rights and scope for each user of the general ledger management system; a data maintenance unit for adding, modifying, searching and deleting information; an account opening unit for setting opening balances of accounting subjects when the general ledger management system is initially put into use; a journal ledger management unit for setting different types of vouchers, and entering the vouchers to a general ledger; a voucher carrying forward unit for automatically carrying forward subsidiary ledgers of an external financial system to vouchers of the general ledger; a posting unit for entering data in vouchers to transaction records of accounting subjects of the general ledger, and calculating gross balances of the accounting subjects; an account balancing unit for balancing accounts to obtain closing balances; and a statement generating unit for generating various financial statements according to statement generating conditions and statement templates set by users.

Further, the present invention provides a general ledger management method comprising the steps of: (a) setting basic information through a user interface; (b) determining whether a general ledger management system is being used for a first time; (c) opening accounts manually if the general ledger management system is being used for the first time; (d) determining whether there is an applicable external financial system; (e) carrying forward external ledgers to vouchers of a general ledger if there is an applicable external financial system; (f) entering journal ledgers in vouchers of the general ledger if there is no applicable external financial system; (g) posting the vouchers to the general ledger; (h) balancing accounts of the general ledger management system; and (i) generating a financial statement.

Other objects, advantages and novel features of the present invention will be drawn from the following detailed description with reference to the attached drawings, in which:

### BRIEF DESCRIPTION OF THE DRAWINGS

FIG. 1 is a schematic diagram of hardware infrastructure of a general ledger management system in accordance with a preferred embodiment of the present invention;

FIG. 2 is a schematic diagram of main function units of an application server of the general ledger management system of FIG. 1;

FIG. 3 is a flowchart of a preferred method for implementing the general ledger management system of the present invention; and

FIG. 4 is a flowchart of details of one step of FIG. 3, namely entering journal ledgers in vouchers of a general ledger.

### DETAILED DESCRIPTION OF THE INVENTION

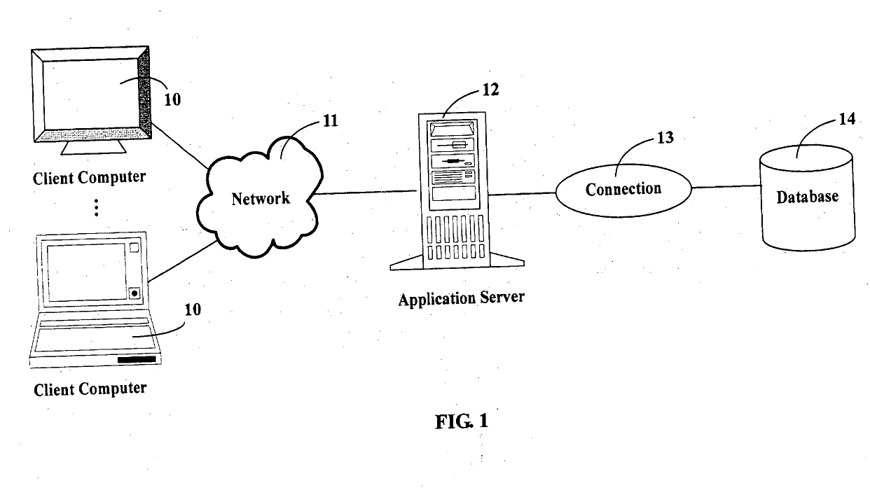

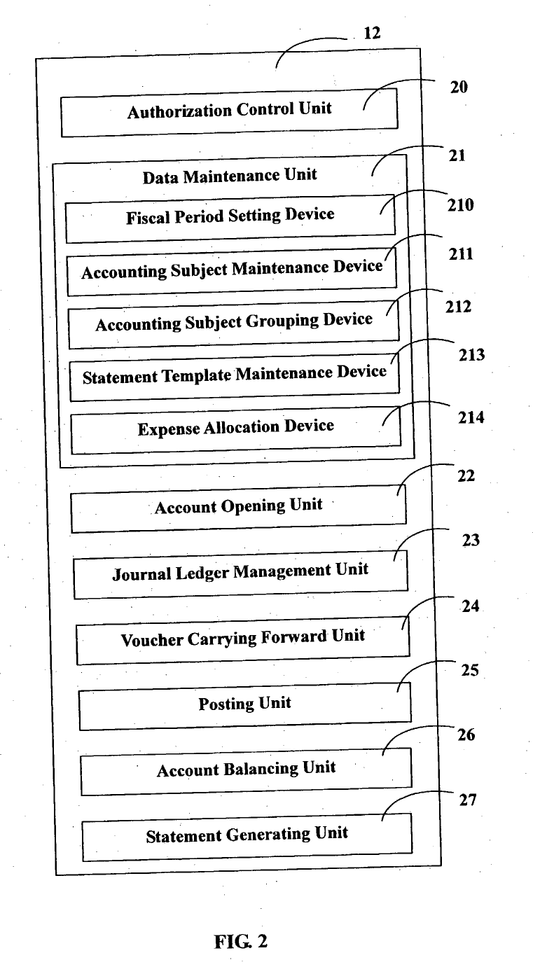

FIG. 1 of the drawings is a schematic diagram of hardware infrastructure of a general ledger management system in accordance with a preferred embodiment of the present invention. The general ledger management system comprises a plurality of client computers 10, an application server 12, and a database 14 for storing various financial data. The client computers 10 are connected to the application server 12 through an electronic network 11, which may, for example, be an intranet or the Internet. The application server 12 is connected to the database 14 through a connection 13. The connection 13 is database connectivity such as Open Database Connectivity (ODBC), or Java Database Connectivity (JDBC). Each client computer 10 provides an interactive user interface for maintaining basic information, and defining and displaying financial statements. The application server 12 comprises a plurality of function units (as shown in FIG. 2) for analyzing financial data obtained from the client computers 10, and for returning analysis results to the client computers 10.

FIG. 2 is a schematic diagram of main function units of the application server 12. The application server 12 comprises an authorization control unit 20, a data maintenance unit 21, an account opening unit 22, a journal ledger management unit 23, a voucher carrying forward unit 24, a posting unit 25, an account balancing unit 26, and a statement generating unit 27. The authorization control unit 20 is for defining and controlling operational rights and scope for each user of the general ledger management system. The data maintenance unit 21 is for maintaining basic information, such as adding, modifying, searching and deleting basic information. The data maintenance unit 21 comprises a fiscal period setting device 210, an accounting subject maintenance device 211, an accounting subject grouping device 212, a statement template maintenance device 213, and an expense allocation device 214. The fiscal period setting device 210 is for setting a fiscal year or a fiscal period. This allows a user to define a particular fiscal year or period to generate an individualized statement. The accounting subject maintenance device 211 is for maintaining accounting subjects, structures of accounting subjects and subject segmenting. Said structures of accounting subjects show interrelationships between main subjects and affiliated subjects. Said subject segmenting refers to configuring of accounting subjects. Customarily, an accounting subject can be divided into four sections. The first section is called a main subject, and the second section is called an affiliated subject. Users can define the two other sections. For example, a user may define the third section as a department code, and the fourth section as a product code. The accounting subject grouping device 212 maintains accounting subject groupings. Accounting subjects can be grouped according to main subject or affiliated subject. If grouped under main subject, each accounting subject grouping comprises at least one main subject. If grouped under affiliated subject, each accounting subject grouping comprises at least one affiliated subject. The statement template maintenance device 213 maintains types, typesetting and formats of financial statements. Said financial statements include balance sheets, statements of profit and loss, comparative financial statements, and combined financial statements. The expense allocation device 214 maintains allocated expenses. Expenses can be allocated by fixed quantity or fixed rate.

The account opening unit 22 sets opening balances for accounting subjects when the general ledger management system is initially put into use.

The journal ledger management unit 23 is for setting different types of vouchers, and entering the vouchers to a general ledger of the general ledger management system.

The voucher carrying forward unit 24 automatically carries forward subsidiary ledgers of an external financial system to vouchers of the general ledger. Said external financial system may include an accounts receivable management subsystem, an accounts payable management subsystem, a note management subsystem, and a fixed asset management subsystem.

The posting unit 25 is used for transferring data in vouchers to transaction records of accounting subjects of the general ledger, and for calculating gross balances of accounting subjects.

The account balancing unit 26 is for balancing accounts of different fiscal years or fiscal periods.

The statement generating 27 generates different financial statements according to statement generating conditions and statement templates set by a user. If a financial statement of a particular department needs to be generated, the user can analyze accounting subjects relating to the department to generate the financial statement. If a comparative statement of profit and loss between different departments needs to be generated, the user can select accounting subject groupings of profit and loss relating to the departments, and analyze accounting subjects in the groupings to generate the comparative statement.

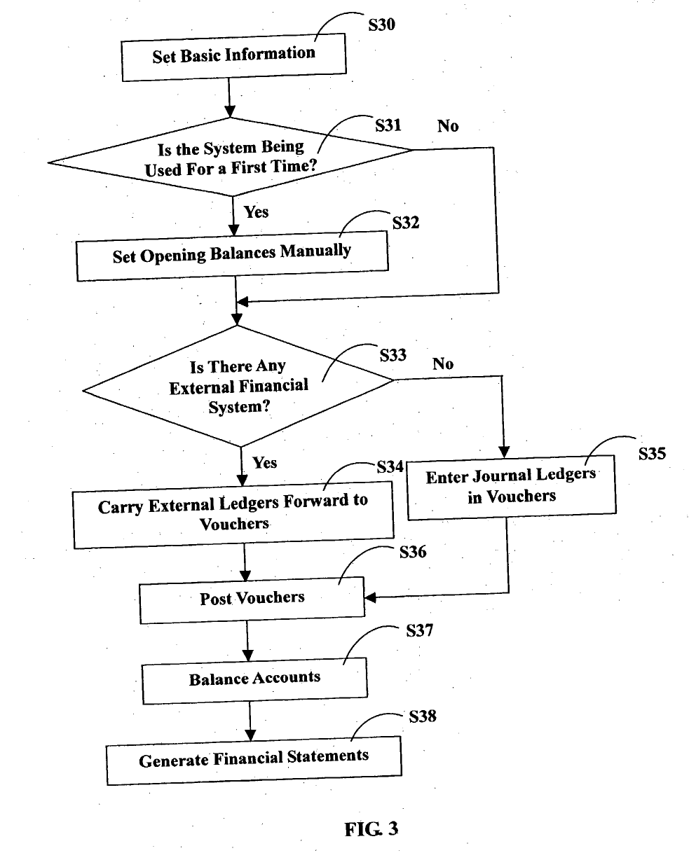

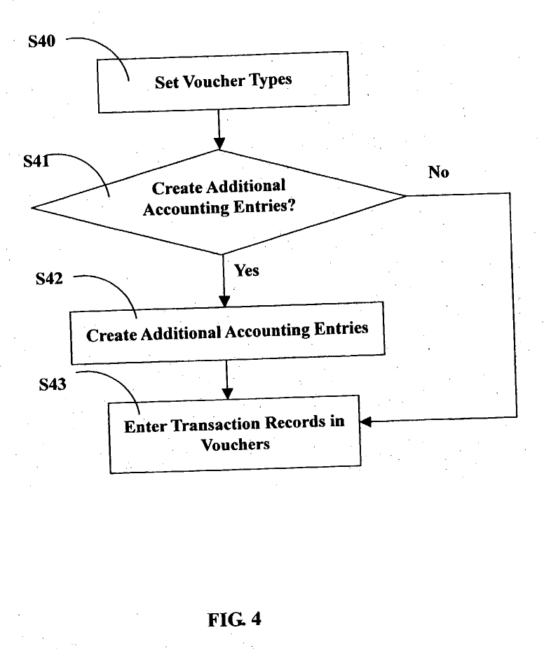

FIG. 3 is a flowchart of a preferred method for implementing the general ledger management system of the present invention. In step S30, a user sets basic information such as fiscal years or fiscal periods, accounting subjects, and accounting subject groupings. The settings are stored in the database 14, and can be searched by any user through any client computer 10. In step S31, the user determines whether the general ledger management system is being put into use for the first time. If the general ledger management system is being put into use for the first time, in step S32, the user opens accounts manually, sets an opening balance for each accounting subject, and stores the opening balances in the database 14. Thereupon, the procedure proceeds to step S33 described below. If the opening balances have been set beforehand, the procedure proceeds directly to step S33. In step S33, the general ledger management system determines whether there is an applicable external financial system. If there is an applicable external financial system, in step S34, the general ledger management system automatically carries forward vouchers; that is, the general ledger management system carries forward subsidiary ledgers of the external financial system to vouchers of the general ledger. Thereupon, the procedure proceeds to step S36 described below. If there is no applicable external financial system, in step S35, the general ledger management system facilitates entering of journal ledgers in vouchers of the general ledger. That is, the user inputs detailed transaction records to vouchers of the general ledger according to other data such as source transaction documents and vouchers. The process of entering journal ledgers in vouchers is described in more detail below with reference to FIG. 4. Thereupon, the procedure proceeds to step S36 described below.

To ensure accuracy of data in the general ledger, each voucher of the general ledger comprises a blank indicating whether the voucher is posted to the general ledger. The user can search vouchers that are not posted through any client computer 10. In step S36, the general ledger management system automatically posts the vouchers into the general ledger by inputting sums of money in accounting subjects of the vouchers to corresponding transaction records of the general ledger, and by calculating balances of the accounting subjects according to the opening balances and the transaction records. The vouchers that are posted are marked accordingly. In step S37, the system automatically balances accounts to obtain closing balances of all accounting subjects and accounting subject groupings. The closing balances are stored in the database 14, and can be searched by the user through any client computer 10. In step S38, the system generates a financial statement according to formats set by the user. The formats include a statement template, a fiscal period, and settings of accounting subjects and accounting subject groupings.

FIG. 4 is a flowchart of details of step S35 of FIG. 3, namely entering journal ledgers in vouchers of the general ledger. In step S40, the user sets different types of vouchers. For instance, the vouchers can be set as accounts receivable, accounts payable, cash, deposits and fixed assets. The vouchers are stored in the database 14, and can be accessed by the user through any client computer 10. In step S41, the system determines whether additional accounting entries need to be created. If so, in step S42, the general ledger management system creates additional accounting entries. Creating additional accounting entries refers to defining a set of accounting entries that can be directly used during entering of journal ledgers in vouchers. Said accounting entries include fixed-quantity expense allocation entries, fixed-rate expense allocation entries, and conventional entries. Thereupon, the procedure proceeds to step S43 described below. If additional accounting entries do not need to be created, the procedure proceeds directly to step S43. In step S43, the user enters transaction records in vouchers by inputting transaction records to corresponding blanks in the vouchers. If additional accounting entries are set beforehand, the system generates transaction entries according to the additional accounting entries. Otherwise, the user selects corresponding accounting subjects, and sets sums of money in debit and credit. The generated vouchers are automatically marked as not posted, and stored in the database 14. The user can search the vouchers, check the vouchers, and post the vouchers to the general ledger through any client computer 10.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A general ledger management system connected to at least one external financial system for obtaining transaction records from the at least one external financial system, the general ledger management system comprising:
a plurality of client computers, each of the client computers providing a user interface for inputting and displaying data;
a database for storing information including opening balances and closing balances of accounting subjects; and
an application server comprising:
an authorization control unit for defining and controlling operational rights and scope for each of users of the general ledger management system;
a data maintenance unit for adding, modifying, searching and deleting information;
an account opening unit for setting opening balances of accounting subjects when the general ledger management system is initially put into use;
a journal ledger management unit for setting different types of vouchers, and for entering the vouchers to a general ledger;
a voucher carrying forward unit for automatically carrying forward subsidiary ledgers of an external financial system to vouchers of the general ledger;
a posting unit for entering data in vouchers to transaction records of accounting subjects of the general ledger, and calculating gross balances of accounting subjects;
an account balancing unit for balancing accounts to obtain closing balances; and
a statement generating unit for generating various desired financial statements according to statement generating conditions and statement templates set by a user.

2. The general ledger management system according to claim 1, wherein the data maintenance unit comprises a fiscal period setting device for setting fiscal years and fiscal periods.

3. The general ledger management system according to claim 1, wherein the data maintenance unit comprises an accounting subject maintenance device for maintaining accounting subjects, structures of accounting subjects and subject segmenting.

4. The general ledger management system according to claim 1, wherein the data maintenance unit comprises an accounting subject grouping device for maintaining accounting subject groupings.

5. The general ledger management system according to claim 1, wherein the data maintenance unit comprises a statement template maintenance device for setting types, typesetting and formats of financial statements.

6. The general ledger management system according to claim 1, wherein the data maintenance unit comprises an expense allocation device for maintaining allocated expenses.

7. The general ledger management system according to claim 1, wherein the external financial system can comprise an accounts receivable management subsystem, an accounts payable management subsystem, a note management subsystem, and a fixed asset management subsystem.

8. A general ledger management method using a general ledger management system, the method comprising the steps of:
(a) setting basic information through a user interface;
(b) determining whether the general ledger management system is being used for a first time;
(c) opening accounts manually if the general ledger management system is being used for the first time;
(d) determining whether there is an applicable external financial system;
(e) carrying forward external ledgers to vouchers of a general ledger if there is an applicable external financial system;
(f) entering journal ledgers in vouchers of the general ledger if there is no applicable external financial system;
(g) posting the vouchers to the general ledger;
(h) balancing accounts of the general ledger management system; and
(i) generating a financial statement.

9. The method according to claim 8, wherein step (a) comprises the step of defining fiscal years or fiscal periods.

10. The method according to claim 8, wherein step (f) comprises the step of setting one or more different types of vouchers, and entering the vouchers to the general ledger.

11. The method according to claim 8, wherein step (i) comprises the step of setting statement generating conditions through the user interface.

12. The method according to claim 8, further comprising the step of creating additional accounting entries for entering journal ledgers in vouchers of the general ledger.

13. A method of running a ledger management system capable of automatically generating entries and accounting vouchers based upon external financial systems, comprising steps of:
(a) providing a ledger management system linked to a plurality of external financial systems;
(b) setting basic information through a user interface;
(c) determining whether the general ledger management system is being used for a first time;
(d) opening accounts manually if the general ledger management system is being used for the first time;
(e) carrying forward external ledgers to vouchers of a general ledger;
(f) posting the vouchers to the general ledger;
(g) balancing accounts of the general ledger management system; and
(h) generating a financial statement.
